(19) United States
(12) Patent Application Publication
(10) Pub. No.: US 2026/0112054 A1
(43) Pub. Date: Apr. 23, 2026

(54) METHOD AND APPARATUS FOR ESTIMATING ROTATION OF VIDEO, AND ELECTRONIC DEVICE AND STORAGE MEDIUM

(71) Applicant: Beijing Zitiao Network Technology Co., Ltd., Haidian District, Beijing (CN)

(72) Inventors: Hengkai GUO, Beijing (CN); Jiawei WEN, Beijing (CN)

(21) Appl. No.: 19/110,015

(22) PCT Filed: Sep. 1, 2023
(86) PCT No.: PCT/CN2023/116492

§ 371 Date: Mar. 7, 2025

(30) Foreign Application Priority Data
Sep. 9, 2022 (CN) 202211104575.9

(51) Int. Cl. G06T 7/73; G06T 7/246

(52) U.S. Cl. CPC G06T 7/74; G06T 7/248; G06T 2207/10016; G06T 2207/20021

(57) ABSTRACT

A method and apparatus for estimating the rotation of a video, and an electronic device and a storage medium. The method for estimating video rotation includes: calculating a global rotation initial value of a current frame of image and an intrinsic matrix of an image acquiring apparatus according to a first matching relationship; calculating a homography matrix between the current frame of image and each of M frames of images before and after the current frame of image according to a second matching relationship; setting a loss function according to the global rotation initial value and the intrinsic matrix, and minimizing the loss function by using an optimization method to obtain a final loss function; and calculating a global rotation optimization value of the current frame of image according to the final loss function and multiple homography matrices.

This application claims priority to Chinese Patent Application No. 202211104575.9, filed to the China National Intellectual Property Administration on Sep. 9, 2022, the entire content of which is herein incorporated by reference.

### TECHNICAL FIELD

The present disclosure relates to a field of computer technologies, for example, relates to a method for estimating video rotation, an apparatus therefor, an electronic device, and a storage medium.

### BACKGROUND

In the prior related art, it is sometimes necessary to estimate rotation that occurs in a video file. In general, the following methods are commonly used in the related art to estimate video rotation:

Method 1: Rotation average algorithm.

In this method, global rotation can be solved based on relative rotation between multiple two-frame images. The computation speed of this method is fast, but since information of 2 dimension (2D) spatial points is not used in this method, the fitting degree of the solved rotation in a picture cannot be guaranteed. As a result, the estimation precision is not high.

Method 2: Structure from motion (SFM) algorithm, or simultaneous localization and mapping (SLAM) algorithm.

In the above methods, the SFM algorithm or SLAM algorithm can be employed to directly solve poses (translation+rotation) of each frame of an entire video and coordinates of 3-dimension (3D) spatial points in a scenario. The estimation precision of this method is high, but the computation speed is slow. Moreover, this method is prone to failure in many motion modes and scenarios, and its robustness cannot be guaranteed. Moreover, the above algorithms are based on a case where relatively large translation has occurred. If no translation occurs, the precision of a computed result will be poor.

In addition, there is richly diverse motion in practical application scenarios, such as picture stillness, pure translation, pure rotation, pure distant view, etc. Therefore, there are corresponding bad cases for different algorithms in the related art.

### SUMMARY

The present disclosure provides a method for estimating video rotation, an apparatus therefor, an electronic device, and a storage medium.

In a first aspect, the present disclosure provides a method for estimating video rotation, including:
calculating a global rotation initial value of a current frame of image and an intrinsic matrix of an image acquiring apparatus according to a matching relationship between the current frame of image and each of K frames of images before and after the current frame of image for each frame of image in a video to be processed, wherein K is a natural number, and the K frames of images before and after the current frame of image include K frames of images before the current frame of image and K frames of images after the current frame of image;
calculating a homography matrix between the current frame of image and each of M frames of images before and after the current frame of image according to a matching relationship between the current frame of image and each of M frames of images before and after the current frame of image, wherein M is a natural number less than or equal to K, and the M frames of images before and after the current frame of image include M frames of images before the current frame of image and M frames of images after the current frame of image;
setting a loss function according to the global rotation initial value of the current frame of image and the intrinsic matrix of the image acquiring apparatus, and minimizing the loss function by using an optimization method to obtain a final loss function; and
calculating a global rotation optimization value of the current frame of image according to the final loss function and multiple homography matrices.

In a second aspect, the present disclosure provides an apparatus for estimating video rotation, including a preliminary computation module and an optimization module;
the preliminary computation module is configured to calculate a global rotation initial value of a current frame of image and an intrinsic matrix of an image acquiring apparatus according to a matching relationship between the current frame of image and each of K frames of images before and after the current frame of image for each frame of image in a video to be processed, wherein K is a natural number, and the K frames of images before and after the current frame of image include K frames of images before the current frame of image and K frames of images after the current frame of image;
the optimization module is configured to calculate a homography matrix between the current frame of image and each of M frames of images before and after the current frame of image according to a matching relationship between the current frame of image and each of M frames of images before and after the current frame of image, wherein M is a natural number less than or equal to K, and the M frames of images before and after the current frame of image include M frames of images before the current frame of image and M frames of images after the current frame of image; set a loss function according to the global rotation initial value of the current frame of image and the intrinsic matrix of the image acquiring apparatus, and minimizing the loss function by using an optimization method to obtain a final loss function; and calculate a global rotation optimization value of the current frame of image according to the final loss function and multiple homography matrices.

In a third aspect, the present disclosure provides an electronic device, including a memory, a processor, a bus, and a computer program that is stored on the memory and executable on the processor, wherein the processor, when executing the computer program, implements the method for estimating video rotation as described in the first aspect.

In a fourth aspect, the present disclosure provides a non-transient computer-readable storage medium storing a computer program that, when executed by a processor, implements the method for estimating video rotation as described in the first aspect.

### BRIEF DESCRIPTION OF DRAWINGS

FIG. 1 is a flowchart of a method for estimating video rotation provided by an embodiment of the present disclosure;

FIG. 2 is a flowchart of another method for estimating video rotation provided by an embodiment of the present disclosure;

FIG. 3 is a structural schematic diagram of an apparatus for estimating video rotation provided by an embodiment of the present disclosure; and

FIG. 4 is a structural schematic diagram of an electronic device provided by an embodiment of the present disclosure.

### DETAILED DESCRIPTION

The following illustrations are exemplary and are intended to illustrate the present disclosure. Unless otherwise specified, all technical and scientific terms used herein have the same meanings as those commonly understood by those of ordinary skill in the art to which the present disclosure belongs.

The terms used herein are only for describing specific implementations. As used herein, unless otherwise specified in the context, the singular form is also intended to include the plural form. Furthermore, when the terms “include/including” and/or “comprise/comprising” are used in this description, they indicate the presence of features, steps, operations, devices, components and/or combinations thereof.

The present disclosure will be illustrated below in conjunction with the accompanying drawings and specific embodiments.

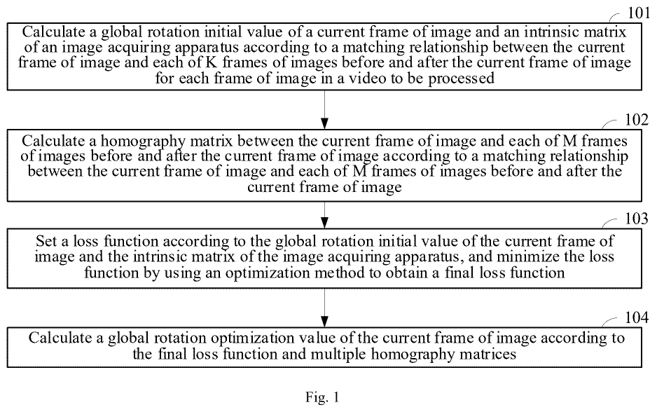

FIG. 1 is a flowchart of a method for estimating video rotation provided by an embodiment of the present disclosure. As shown in FIG. 1, the method for estimating video rotation in an embodiment of the present disclosure includes steps of:

Step 101: calculating a global rotation initial value of a current frame of image and an intrinsic matrix of an image acquiring apparatus according to a matching relationship between the current frame of image and each of K frames of images before and after the current frame of image for each frame of image in a video to be processed.

When the video rotation is estimated, a video where rotation may occur from a video file is commonly specified or identified for estimation. Therefore, a video specified or identified can be used as the video to be processed.

In a technical solution of the present disclosure, a same operation needs to be performed for each frame of image in a video to be processed: calculating a global rotation initial value of a current frame of image and an intrinsic matrix of an image acquiring apparatus according to a matching relationship between the current frame of image and each of K frames of images before the current frame of image, where K is a natural number, and the K frames of images before and after the current frame of image include K frames of images before the current frame of image and K frames of images after the current frame of image.

In one implementation of the present disclosure, for an a-th frame of image in a video to be processed, the a-th frame of image may serve as a current frame of image, and then a global rotation initial value of the current frame of image and an intrinsic matrix of an image acquiring apparatus are calculated according to a matching relationship between the current frame of image and each of K frames of images before and after the current frame of image.

In addition, in a technical solution of the present disclosure, the global rotation initial value of the current frame of image and the intrinsic matrix of the image acquiring apparatus can be calculated by using multiple ways. The technical solution of the present disclosure will be introduced below with one of the implementations as an example.

In one implementation of the present disclosure, the calculate a global rotation initial value of a current frame of image and an intrinsic matrix of an image acquiring apparatus according to a matching relationship between the current frame of image and each of K frames of images before and after the current frame of image may include steps of:

Step 11: calculating a fundamental matrix between the current frame of image and each of K frames of images before and after the current frame of image according to the matching relationship between the current frame of image and each of K frames of images before and after the current frame of image.

In this step, the matching relationship between the current frame of image and each of K frames of images before and after the current frame of image needs to be acquired for each frame of image in the video to be processed, where K is a natural number.

In one implementation of the present disclosure, assuming that a value of K is 40, for an a-th frame of image in the video to be processed, a matching relationship between the a-th frame of image and each of an (a−40)th frame of image to an (a−1)th frame of image (first 40 frames of images), and an (a+1)th frame of image to an (a+40)th frame of image (last 40 frames of images) will be acquired. Since a matching relationship can be acquired between every two frames of images, a total of 80 matching relationships can be obtained.

By analogy, for each frame of image in a video to be processed, it can be processed as described above, and a corresponding matching relationship can be obtained.

In addition, in a technical solution of the present disclosure, the value of K can be preset according to actual application needs.

In one implementation of the present disclosure, the value of K may be 30, 40 or 50. It may also be other suitable values, which will not be listed one by one here.

In addition, in a technical solution of the present disclosure, the matching relationship between the current frame of image and each of K frames of images before and after the current frame of image can be acquired by using multiple ways.

In one implementation of the present disclosure, feature extraction and matching can be performed on the current frame of image and each of K frames before and after the current frame of image to obtain the matching relationship between the current frame of image and each of K frames of images before and after the current frame of image.

In one implementation of the present disclosure, the matching relationship may be a matching point pair between two frames of images.

In a technical solution of the present disclosure, after a matching relationship between the current frame of image and each of K frames of images before and after the current frame of image is obtained, a fundamental matrix between the current frame of image and each of the above-mentioned frames of images can be calculated according to the matching relationship.

In a technical solution of the present disclosure, the fundamental matrix between the current frame of image and each of the above-mentioned frames of images can be calculated by using multiple ways.

In one implementation of the present disclosure, for two frames of images, a fundamental matrix between the two frames of images can be calculated according to the matching relationship between the two frames of images by direct linear transformation (e.g., 8-point method+least square method).

In one implementation of the present disclosure, for two frames of images, a fundamental matrix between the two frames of images can be calculated according to the matching relationship between the two frames of images by a random sample consensus (RANSAC) algorithm.

Step 12: calculating the global rotation initial value of the current frame of image and the intrinsic matrix of the image acquiring apparatus according to multiple obtained fundamental matrices.

In a technical solution of the present disclosure, after multiple fundamental matrices are obtained, the global rotation initial value of the current frame of image and the intrinsic matrix of the image acquiring apparatus can be calculated according to the multiple obtained fundamental matrices.

In a technical solution of the present disclosure, the global rotation initial value of the current frame of image and the intrinsic matrix of the image acquiring apparatus can be calculated by using multiple ways according to the multiple obtained fundamental matrices.

In one implementation of the present disclosure, the calculate the global rotation initial value of the current frame of image and the intrinsic matrix of the image acquiring apparatus according to multiple obtained fundamental matrices may include steps of:

Step 121: calculating a relative rotation relationship and a relative translation relationship between the current frame of image and each of K frames of images before and after the current frame of image, and the intrinsic matrix of the image acquiring apparatus according to the multiple fundamental matrices.

The fundamental matrix includes an important geometric relationship between images obtained from different viewpoints, describing epipolar constraint conditions that are met between corresponding points, and also includes all intrinsic parameter and extrinsic parameter information of an image acquiring apparatus (e.g., a camera, a camcorder, or a pick-up head).

Therefore, in a technical solution of the present disclosure, after the multiple fundamental matrices are obtained, each fundamental matrix can be decomposed. Thereby, the relative rotation relationship and the relative translation relationship between the current frame of image and each frame of image can be obtained, and the intrinsic matrix of the image acquiring apparatus can be calculated according to the fundamental matrix.

In one implementation of the present disclosure, the intrinsic matrix of the image acquiring apparatus can be calculated according to the fundamental matrix by a self-calibration method (a method for solving intrinsic parameters of the image acquiring apparatus by features of an image itself).

Step 122: calculating the global rotation initial value of the current frame of image according to the relative rotation relationship between the current frame of image and each of K frames of images before and after the current frame of image.

In a technical solution of the present disclosure, after the relative rotation relationship between the current frame of image and each frame of image is obtained, the global rotation initial value of the current frame of image can be calculated according to the relative rotation relationship between the current frame of image and each frame of image.

In a technical solution of the present disclosure, the global rotation initial value of the current frame of image can be calculated by using multiple ways.

In one implementation of the present disclosure, the global rotation initial value of the current frame of image can be calculated can be calculated according to the relative rotation relationship between the current frame of image and each of K frames of images before and after the current frame of image by a rotation average algorithm.

By analogy, for each frame of image in a video to be processed, it can be processed as described above, and the global rotation initial value of each frame of image is obtained.

Step 102: calculating a homography matrix between the current frame of image and each of M frames of images before and after the current frame of image according to a matching relationship between the current frame of image and each of M frames of images before and after the current frame of image.

In a technical solution of the present disclosure, after the global rotation initial value of the current frame of image is obtained, optimization can be performed to improve the precision of global rotation.

Therefore, in this step, the homography matrix between the current frame of image and each of M frames of images before and after the current frame of image can be calculated according to the matching relationship between the current frame of image and each of M frames of images before and after the current frame of image, where M is a natural number less than or equal to K, and the M frames of images before and after the current frame of image include M frames of images before the current frame of image and M frames of images after the current frame of image.

In a technical solution of the present disclosure, the homography matrix between the current frame of image and each of M frames of images before and after the current frame of image can be calculated according to the matching relationship between the current frame of image and each of M frames of images before and after the current frame of image by using multiple ways.

In one implementation of the present disclosure, the calculate a homography matrix between the current frame of image and each of M frames of images before and after the current frame of image according to a matching relationship between the current frame of image and each of M frames of images before and after the current frame of image may include:

Step 21: downsampling the matching relationship between the current frame of image and each of its M frames of images.

In this step, firstly, the matching relationship between the current frame of image and each of M frames of images before and after the current frame of image is downsampled, to obtain multiple downsampled matching relationships, where M is a natural number less than or equal to K.

In a technical solution of the present disclosure, the matching relationship between the current frame of image and each of M frames of images before and after the current frame of image can be downsampled by using multiple ways.

In one implementation of the present disclosure, downsampling a matching relationship between two frames of images may include:

Step 211: dividing each of the two frames of images into corresponding N×N grids, where an initial state of each grid is null, and N is a value preset according to an actual application scenario.

Step 212: selecting an unselected matching point pair from matching point pairs in the two frames of images.

Step 213: retaining the selected matching point pair when a state of a grid where any point in the selected matching point pair is located is null, and setting states of grids where two points in the selected matching point pair are located to be non-null; and deleting the selected matching point pair when the states of the grids where the two points in the selected matching point pair are located are all non-null.

Step 214: returning to perform the step 212 when an unselected matching point pair exists among the matching point pairs in the two frames of images.

Through the above steps 211 to 214, the matching relationship between the two frames of images can be downsampled, and the matching point pairs between the two frames of images can be reduced, and thereby, a corresponding computation workload can be effectively reduced.

In addition, in a technical solution of the present disclosure, the value of M can be preset according to actual application needs.

In one implementation of the present disclosure, the value of M may be 3, 4 or 5. It may also be other suitable values, which will not be listed one by one here.

When the value of M is much less than that of K, the corresponding computation workload can be reduced, and the computation speed can be improved.

Step 22: calculating the homography matrix between the current frame of image and each of M frames of images before and after the current frame of image according to multiple downsampled matching relationships.

The homography matrix is generally used to describe a mapping relationship between points on a same plane between different images, and it is a homogeneous matrix of 3×3. Two images to be stitched can be stitched together by the homography matrix.

Therefore, in a technical solution of the present disclosure, after the downsampled matching relationship between the current frame of image and each of M frames of images before and after the current frame of image is obtained, the homography matrix between the current frame of image and each of M frames of images before and after the current frame of image can be calculated according to the multiple downsampled matching relationships.

Step 103: setting a loss function according to the global rotation initial value of the current frame of image and the intrinsic matrix of the image acquiring apparatus, and minimizing the loss function by using an optimization method to obtain a final loss function.

In a technical solution of the present disclosure, after the global rotation initial value of the current frame of image and the intrinsic matrix of the image acquiring apparatus are obtained, a corresponding loss function can be set according to the global rotation initial value of the current frame of image and the intrinsic matrix of the image acquiring apparatus. Then, the loss function e is minimized by using the optimization method to obtain a minimized loss function.

In a technical solution of the present disclosure, the loss function can be set by using multiple ways. The technical solution of the present disclosure will be illustrated below with one of the implementations as an example.

In one implementation of the present disclosure, the loss function e can be represented as:

$$e = {\sum }_{i = 1}^{n} {\sum }_{j ∈ I ( i )} {\sum }_{k ∈ F ( i , j )} h ( {r}_{ij}^{k} )$$

Where e is the loss function, n is a total number of frames of a video to be processed, i represents an ith frame, j represents a jth frame, I(i) represents all adjacent frames of an ith frame of video; F(i, j) represents a set of matching point pairs between the ith frame and the jth frame, k is a serial number of the matching point pair, h is a kernel function, and

$${r}_{ij}^{k}$$

is a re-projection error or a kin matching point pair between the ith frame and the jth frame.

In one implementation of the present disclosure,

$${r}_{ij}^{k}$$

can be represented as:

$${r}_{ij}^{k} = {u}_{i}^{k} - {p}_{ij}^{k}$$

Where

$${r}_{ij}^{k}$$

is a re-projection error of the kth matching point pair between the ith frame and the jth frame

$${u}_{i}^{k}$$

is coordinates of a point in the kth matching point pair on the/tn frame, and

$${p}_{ij}^{k}$$

is coordinates of a point obtained after a three-dimension spatial point corresponding to the kth matching point pair between the ith frame and the jth frame is projected through the homography matrix.

In one implementation of the present disclosure, a matrix of

$${p}_{ij}^{k}$$

can be represented as:

$${\tilde{p}}_{ij}^{k} = {K}_{i} {R}_{i} {R}_{j}^{T} {K}_{j}^{- 1} {\tilde{u}}_{j}^{i}$$

Where Kᵢ is an intrinsic matrix of the image acquiring apparatus in the ith frame, Rᵢ is a global rotation initial value of the ith frame, Rⱼ is a global rotation initial value of the jth frame, Kⱼ is an intrinsic matrix of the image acquiring apparatus in the jth frame, and

$${u}_{j}^{l}$$

is coordinates of the lt matching point pair on the jth frame.

In one implementation of the present disclosure, the kernel function h may be any robust kernel function.

In one implementation of the present disclosure, the kernel function h may be represented as:

$$h ( X ) = \{ \begin{matrix}{\vert X \vert}^{2} , if \vert X \vert < σ \\ 2 σ \vert X \vert - {σ}^{2} , if \vert X \vert \geq σ\end{matrix}$$

Where h is the kernel function, x is an independent variable of the kernel function, representing an error, and o is a standard deviation of the error.

In a technical solution of the present disclosure, the loss function can be minimized by using multiple optimization methods.

In one implementation of the present disclosure, the loss function can be minimized by using a nonlinear least square method to obtain a minimized loss function. Other suitable optimization methods can also be used, which will not be listed one by one here.

Step 104: calculating a global rotation optimization value of the current frame of image according to the final loss function and multiple homography matrices.

In a technical solution of the present disclosure, since only a value of global rotation in the above-mentioned loss function is an unknown quantity, and other parameters are all known quantities, a global rotation value can be calculated according to the minimized loss function and the multiple homography matrices, and thereby, the value of global rotation can be used as the global rotation optimization value of the current frame.

Through the above steps 101 to 104, the global rotation optimization value of the current frame of image can be calculated.

By analogy, for each frame of image in a video to be processed, it can be processed as described above, and the global rotation optimization value of each frame of image is obtained, and thereby, video rotation can be estimated more accurately.

In addition, in a technical solution of the present disclosure, it is also possible to judge which one is larger between an average re-projection error of two-dimension spatial points (2D points) in the current frame of image and a preset error threshold. If the average re-projection error of the two-dimension spatial points in the current frame of image is less than the preset error threshold, it indicates that the current frame of image is basically not translated. Therefore, the global rotation optimization value of the current frame of image calculated in the step 104 can be used as a global rotation estimated value of the current frame of image.

If the average re-projection error of the two-dimension spatial points in the current frame of image is greater than or equal to the preset error threshold, it indicates that there is a large translation in the current frame of image, and subsequent processing can be performed.

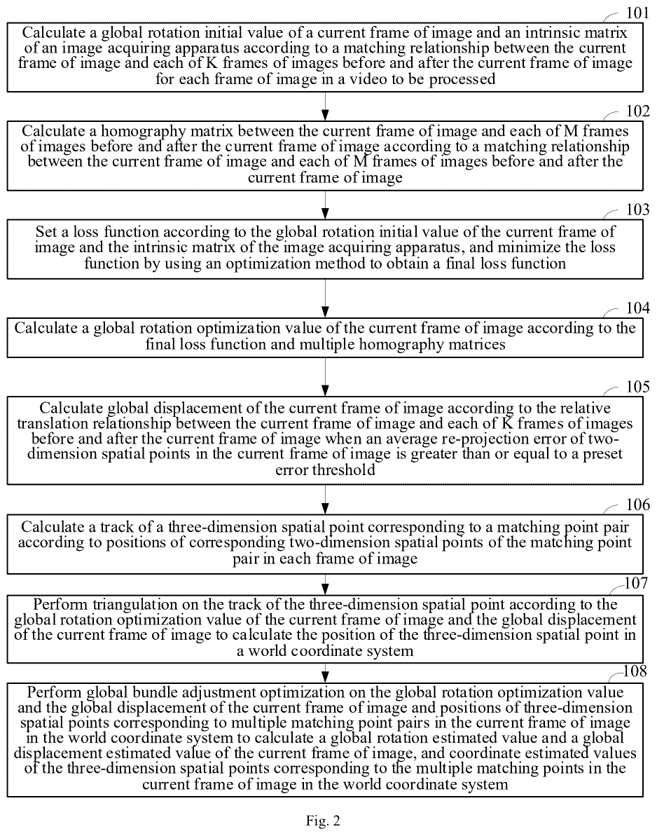

As an example, as shown in FIG. 2, in one implementation of the present disclosure, the method for estimating video rotation may further include steps of:

Step 105: calculating global displacement of the current frame of image according to the relative translation relationship between the current frame of image and each of K frames of images before and after the current frame of image when an average re-projection error of two-dimension spatial points in the current frame of image is greater than or equal to a preset error threshold.

In a technical solution of the present disclosure, it is possible to firstly judge a relationship between the magnitude of an average re-projection error of multiple two-dimension spatial points (2D points) in the current frame of image and the magnitude of a preset error threshold. If the average re-projection error of the two-dimension points in the current frame of image is greater than or equal to the preset error threshold, the global displacement of the current frame of image can be calculated according to the relative translation relationship between the current frame of image and each of K frames of images before and after the current frame of image.

When the above computations are performed, the relative translation relationship between the current frame of image and each of K frames of images before and after the current frame of image obtained in the step 121 can be used, and thereby, a corresponding computation workload can be effectively reduced.

In one implementation of the present disclosure, the global displacement of the current frame of image can be calculated using a translation average algorithm according to the relative translation relationship between the current frame of image and each of K frames of images before and after the current frame of image.

Step 106: calculating a track of a three-dimension spatial point corresponding to a matching point pair according to positions of corresponding two-dimension spatial points of the matching point pair in each frame of image.

When a three-dimension spatial point (3D point) in a world coordinate system is captured by using the image acquiring apparatus (e.g., the camera, the camcorder, or the pick-up head), a projection of the three-dimension point in each frame of image correspond to two-dimension spatial points (2D points) in the frame of image. When the position and/or angle of the image acquiring apparatus change/changes, positions of the two-dimension points corresponding to a same three-dimension point in different frames of images will also change accordingly. Therefore, the track of a corresponding three-dimension point can be obtained according to coordinates of multiple two-dimension points. For example, the positions of multiple two-dimension points corresponding to the same three-dimension point can be cascaded to form the track of the three-dimension point.

In a technical solution of the present disclosure, according to positions of corresponding two-dimension spatial points of a matching point pair in multiple frames of images (i.e., the positions of the two-dimension points corresponding to the same three-dimension point in different frames of images), a track of the three-dimension spatial point corresponding to the matching point pair can be calculated.

In one implementation of the present disclosure, step 106 may include a substep of:

Calculating a corresponding connected domain by taking a matching relationship of two-dimension spatial points between two adjacent frames of images as an edge and the two-dimension spatial points as nodes, where the connected domain serves as a track of a three-dimension spatial point corresponding to the two-dimension spatial points.

In a technical solution of the present disclosure, the track of each three-dimension spatial point can also be downsampled to minimize the corresponding computation workload.

In one implementation of the present disclosure, after obtaining the track of the three-dimension spatial point, the following steps may further be included:

Step 91: dividing each frame of image into N×N grids, where an initial state of each grid is null, and N is a value preset according to an actual application scenario.

Step 92: selecting a track of an unselected three-dimension spatial point from tracks of multiple three-dimension spatial points (for example, the track of an unselected three-dimension spatial point with a maximum length can be selected).

Step 93: retaining the track of the selected three-dimension spatial point when the state of a grid where at least one two-dimension spatial point in the track of the selected three-dimension spatial point is located is null, and setting states of grids where all the two-dimension spatial points corresponding to the track of the selected three-dimension spatial point are located to be non-null; and deleting the track of the selected three-dimension spatial point when the states of the grids where all the two-dimension spatial points corresponding to the track of the selected three-dimension spatial point are located are all non-null.

Step 94: returning to step 92 when the track of the unselected three-dimension spatial point exists among the tracks of the multiple three-dimension spatial points.

Through the above steps 91 to 94, the obtained tracks of the multiple three-dimension spatial points can be downsampled to reduce the tracks of the three-dimension spatial points, and thereby, the corresponding computation workload can be effectively reduced.

Step 107: performing triangulation on the track of the three-dimension spatial point according to the global rotation optimization value of the current frame of image and the global displacement of the current frame of image to calculate the position of the three-dimension spatial point in a world coordinate system.

In a technical solution of the present disclosure, after the track of the three-dimension spatial point is obtained, triangulation is performed on the track of the three-dimension spatial point according to the global rotation optimization value and the global displacement of the current frame of image, and a triangle is constructed using the above-mentioned geometric information, and thereby, the position of the three-dimension spatial point in the world coordinate system can be calculated.

Step 108: performing global bundle adjustment optimization on the global rotation optimization value and the global displacement of the current frame of image and positions of three-dimension spatial points corresponding to multiple matching point pairs in the current frame of image in the world coordinate system to calculate a global rotation estimated value and a global displacement estimated value of the current frame of image, and coordinate estimated values of the three-dimension spatial points corresponding to the multiple matching point pairs in the current frame of image in the world coordinate system.

In a technical solution of the present disclosure, the global bundle adjustment optimization can also be performed on the global rotation optimization value and the global displacement of the current frame of image and the position of the three-dimension spatial point corresponding to the multiple matching point pairs in the current frame of image in the world coordinate system, so that the re-projection error is minimized, and thereby, an optimized global rotation estimated value and a global displacement estimated value of the current frame of image and an coordinate estimated value of the three-dimension spatial point corresponding to the multiple matching point pairs in the current frame of image in the world coordinate system can be finally obtained.

In another implementation of the present disclosure, the method for estimating video rotation may further include:

Calculating a global rotation estimated value, a global displacement estimated value of the current frame of image, and a coordinate estimated value of the three-dimension spatial point corresponding to the multiple matching point pairs in the current frame of image in the world coordinate system by an SFM algorithm when an average re-projection error of two-dimension spatial points in the current frame of image is greater than or equal to a preset error threshold.

In a technical solution of the present disclosure, an apparatus for estimating video rotation is further proposed.

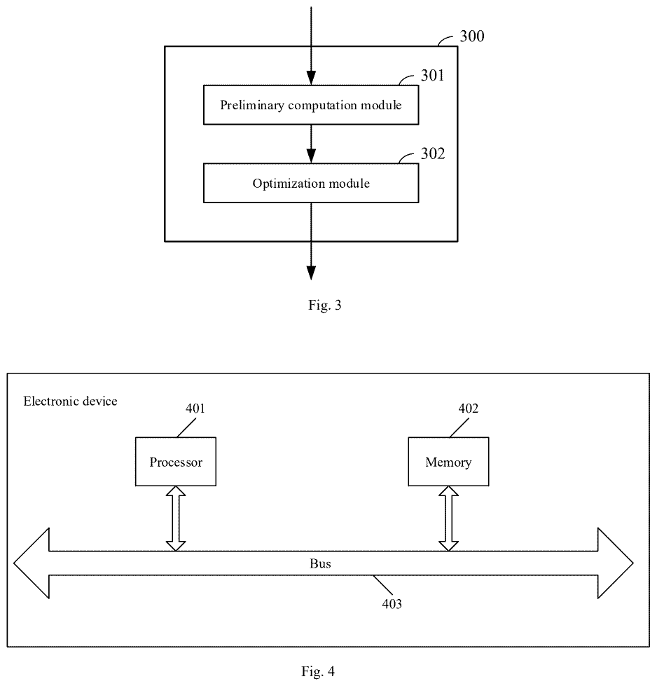

As shown in FIG. 3, an apparatus 300 for estimating video rotation in an embodiment of the present disclosure includes: a preliminary computation module 301 and an optimization module 302.

The preliminary computation module 301 is configured to calculate a global rotation initial value of a current frame of image and an intrinsic matrix of an image acquiring apparatus according to a matching relationship between the current frame of image and each of K frames of images before and after the current frame of image for each frame of image in a video to be processed, where K is a natural number, and the K frames of images before and after the current frame of image include K frames of images before the current frame of image and K frames of images after the current frame of image. The optimization module 302 is configured to calculate a homography matrix between the current frame of image and each of M frames of images before and after the current frame of image according to a matching relationship between the current frame of image and each of M frames of images before and after the current frame of image, where M is a natural number less than or equal to K, and the M frames of images before and after the current frame of image include M frames of images before the current frame of image and M frames of images after the current frame of image; set a loss function according to the global rotation initial value of the current frame of image and the intrinsic matrix of the image acquiring apparatus, and minimize the loss function by using an optimization method to obtain a final loss function; and calculate a global rotation optimization value of the current frame of image according to the final loss function and multiple homography matrices.

In another implementation of the present disclosure, the optimization module 302 can be further configured to calculate global displacement of the current frame of image according to the relative translation relationship between the current frame of image and each of K frames of images before and after the current frame of image when an average re-projection error of two-dimension spatial points in the current frame of image is greater than or equal to a preset error threshold; calculate a track of a three-dimension spatial point corresponding to a matching point pair according to positions of corresponding two-dimension spatial points of the matching point pair in multiple frames of images; perform triangulation on the track of the three-dimension spatial point according to the global rotation optimization value of the current frame of image and the global displacement of the current frame of image to calculate the position of the three-dimension spatial point in a world coordinate system; and perform global bundle adjustment optimization on the global rotation optimization value and the global displacement of the current frame of image and positions of three-dimension spatial points corresponding to multiple matching point pairs in the current frame of image in the world coordinate system to calculate an global rotation estimated value and a global displacement estimated value of the current frame of image, and coordinate estimated values of the three-dimension spatial points corresponding to the multiple matching point pairs in the current frame of image in the world coordinate system.

In another implementation of the present disclosure, the optimization module 302 is configured to calculate a homography matrix between the current frame of image and each of M frames of images before and after the current frame of image according to a matching relationship between the current frame of image and each of M frames of images before and after the current frame of image in the following way:

Downsampling the matching relationship between the current frame of image and each of M frames of images before and after the current frame of image; and calculating the homography matrix between the current frame of image and each of M frames of images before and after the current frame of image according to multiple downsampled matching relationships.

In another implementation of the present disclosure, the optimization module 302 is configured to downsample a matching relationship between two frames of images in the following way:

Dividing each of the two frames of images into corresponding N×N grids, where an initial state of each grid is null, and N is a preset value; selecting an unselected matching point pair from matching point pairs in the two frames of images; retaining the selected matching point pair in a case where a state of a grid where one point in the selected matching point pair is located is null, and setting states of grids where two points in the selected matching point pair are located to be non-null; deleting the selected matching point pair in a case where the states of the grids where the two points in the selected matching point pair are located are all non-null; and returning to perform the operation of selecting an unselected matching point pair from matching point pairs in the two frames of images, in a case where an unselected matching point pair exists among the matching point pairs in the two frames of images.

In another implementation of the present disclosure, the preliminary computation module 301 is configured to:

Calculate a fundamental matrix between the current frame of image and each of K frames of images before and after the current frame of image according to a matching relationship between the current frame of image and each of K frames of images before and after the current frame of image; and calculate a global rotation initial value of the current frame of image and an intrinsic matrix of an image acquiring apparatus according to multiple obtained fundamental matrices.

In another implementation of the present disclosure, the preliminary computation module 301 is configured to calculate a global rotation initial value of the current frame of image and an intrinsic matrix of an image acquiring apparatus according to multiple obtained fundamental matrices in the following way:

Calculating a relative rotation relationship and a relative translation relationship between the current frame of image and each of K frames of images before and after the current frame of image, and the intrinsic matrix of the image acquiring apparatus according to the multiple fundamental matrices; and calculating the global rotation initial value of the current frame of image according to the relative rotation relationship between the current frame of image and each of K frames of images before and after the current frame of image.

In another implementation of the present disclosure, the optimization module 302 is configured to calculate a track of a three-dimension spatial point corresponding to a matching point pair according to positions of corresponding two-dimension spatial points of the matching point pair in multiple frames of images in the following way:

Calculating a connected domain by taking a matching relationship of two-dimension spatial points between two adjacent frames of images as an edge and the two-dimension spatial points as nodes, where the connected domain serves as a track of a three-dimension spatial point corresponding to the two-dimension spatial points.

In another implementation of the present disclosure, the optimization module 302 is further configured to:

Divide each frame of image into N×N grids, where an initial state of each grid is null, and N is a preset value; select a track of an unselected three-dimension spatial point from tracks of multiple three-dimension spatial points; retain the track of the selected three-dimension spatial point in a case where the state of a grid where at least one two-dimension spatial point in the track of the selected three-dimension spatial point is located is null, and set states of grids where all the two-dimension spatial points corresponding to the track of the selected three-dimension spatial point are located to be non-null; delete the track of the selected three-dimension spatial point in a case where the states of the grids where all the two-dimension spatial points corresponding to the track of the selected three-dimension spatial point are located are all non-null; and return to perform the operation to select a track of an unselected three-dimension spatial point from tracks of multiple three-dimension spatial points, in a case where the track of the unselected three-dimension spatial point exists among the tracks of the multiple three-dimension spatial points.

In another implementation of the present disclosure, the optimization module 302 is further configured to:

Calculate a global rotation estimated value, a global displacement estimated value of the current frame of image, and coordinate estimated values of three-dimension spatial points corresponding to multiple matching point pairs in the current frame of image in a world coordinate system by a global structure from motion algorithm in a case where an average re-projection error of two-dimension spatial points in the current frame of image is greater than or equal to a preset error threshold.

The apparatus provided in this embodiment can achieve the same technical effect as in a method embodiment.

In a technical solution of the present disclosure, an electronic device is further proposed.

FIG. 4 shows a structural schematic diagram of an electronic device provided by an embodiment of the present disclosure.

As shown in FIG. 4, the electronic device may include a processor 401, a memory 402, a bus 403, and a computer program stored in the memory 402 and can run in the processor 401, where the processor 401 and the memory 402 communicate with each other via the bus 403. The processor 401, when executing the computer program, implements the steps of the above-mentioned method, for example, including: calculating a global rotation initial value of a current frame of image and an intrinsic matrix of an image acquiring apparatus according to a matching relationship between the current frame of image and each of K frames of images before and after the current frame of image for each frame of image in a video to be processed, where K is a natural number, and the K frames of images before and after the current frame of image include K frames of images before the current frame of image and K frames of images after the current frame of image; calculating a homography matrix between the current frame of image and each of M frames of images before and after the current frame of image according to a matching relationship between the current frame of image and each of M frames of images before and after the current frame of image, where M is a natural number less than or equal to K, and the M frames of images of the current frame of image before and after the current frame of image include M frames of images before the current frame of image and M frames of images after the current frame of image; setting a loss function according to the global rotation initial value of the current frame of image and the intrinsic matrix of the image acquiring apparatus, and minimizing the loss function by using an optimization method to obtain a final loss function; and calculating a global rotation optimization value of the current frame of image according to the final loss function and multiple homography matrices.

In an embodiment of the present disclosure, there is also provided a non-transient computer-readable storage medium having a computer program stored thereon, where the computer program, when executed by a processor, implements the steps of the above-mentioned method, for example, including: calculating a global rotation initial value of a current frame of image and an intrinsic matrix of an image acquiring apparatus according to a matching relationship between the current frame of image and each of K frames of images before and after the current frame of image for each frame of image in a video to be processed, where K is a natural number, and the K frames of images before and after the current frame of image include K frames of images before the current frame of image and K frames of images after the current frame of image; calculating a homography matrix between the current frame of image and each of M frames of images before and after the current frame of image according to a matching relationship between the current frame of image and each of M frames of images before and after the current frame of image, where M is a natural number less than or equal to K, and the M frames of images before and after the current frame of image include M frames of images before the current frame of image and M frames of images after the current frame of image; setting a loss function according to the global rotation initial value of the current frame of image and the intrinsic matrix of the image acquiring apparatus, and minimizing the loss function by using an optimization method to obtain a final loss function; and calculating a global rotation optimization value of the current frame of image according to the final loss function and multiple homography matrices.

To sum up, in a technical solution of the present disclosure, since a matching relationship between the current frame of image and each of K frames of images before and after the current frame of image is acquired for each frame of image in a video to be processed, a fundamental matrix between the current frame of image and each of K frames of images before and after the current frame of image is calculated, and a relative rotation relationship and a relative translation relationship between the current frame of image and each of K frames of images before and after the current frame of image, and an intrinsic matrix of an image acquiring apparatus are calculated according to the fundamental matrices; then, a global rotation initial value of the current frame of image is calculated according to the relative rotation relationship between the current frame of image and each of K frames of images before and after the current frame of image; subsequently, the matching relationship between the current frame of image and each of K frames of images before and after the current frame of image is downsampled, and a homography matrix between the current frame of image and each of M frames of images before and after the current frame of image is calculated according to multiple downsampled matching relationships; subsequently, a loss function is set according to the global rotation initial value of the current frame of image and the intrinsic matrix of the image acquiring apparatus, and the loss function is minimized by using an optimization method to obtain a final loss function; and then, a global rotation optimization value of the current frame of image is calculated according to the final loss function and multiple homography matrices, the rotation of the video can be estimated more accurately.

Moreover, in a technical solution of the present disclosure, since the matching relationship is downsampled in homography optimization, the corresponding computation workload can be greatly reduced, the computation speed is improved, and the efficiency of the system is guaranteed on the whole.

Moreover, in a technical solution of the present disclosure, the track of the three-dimension spatial point is also downsampled, and therefore, the corresponding computation workload can be reduced, and the computation speed can be improved.

Furthermore, a multi-level robust, accurate and efficient video rotation estimation solution is proposed in a technical solution of the present. In this solution, global rotation calculated by the rotation average algorithm can be taken as an initial value, and the accuracy can be improved by using multi-frame homography optimization. Therefore, the estimation accuracy is high, and the problems of rotation estimation in most rotation estimation scenarios (e.g., stillness, pure rotation, distant view and the like). Moreover, a translation scenario can be satisfied by using the SFM algorithm. Therefore, the rotation estimation can be performed whether in a scenario where translation occurs or in a scenario where no translation occurs. Moreover, the precision of an estimated result is high, and thereby, this solution can be applied to more practical application scenarios.

1. A method for estimating video rotation, comprising:
calculating a global rotation initial value of a current frame of image and an intrinsic matrix of an image acquiring apparatus according to a matching relationship between the current frame of image and each of K frames of images before and after the current frame of image for each frame of image in a video to be processed, wherein K is a natural number, and the K frames of images before and after the current frame of image comprise K frames of images before the current frame of image and K frames of images after the current frame of image;
calculating a homography matrix between the current frame of image and each of M frames of images before and after the current frame of image according to a matching relationship between the current frame of image and each of M frames of images before and after the current frame of image, wherein M is a natural number less than or equal to K, and the M frames of images before and after the current frame of image comprise M frames of images before the current frame of image and M frames of images after the current frame of image;
setting a loss function according to the global rotation initial value of the current frame of image and the intrinsic matrix of the image acquiring apparatus, and minimizing the loss function by using an optimization method to obtain a final loss function; and
calculating a global rotation optimization value of the current frame of image according to the final loss function and multiple homography matrices.

2. The method according to claim 1, wherein the calculating a homography matrix between the current frame of image and each of M frames of images before and after the current frame of image according to a matching relationship between the current frame of image and each of M frames of images before and after the current frame of image comprises:
downsampling the matching relationship between the current frame of image and each of M frames of images before and after the current frame of image; and
calculating the homography matrix between the current frame of image and each of M frames of images before and after the current frame of image according to multiple downsampled matching relationships.

3. The method according to claim 2, wherein downsampling a matching relationship between two frames of images comprises:
dividing each of the two frames of images into corresponding N×N grids, wherein an initial state of each grid is null, and N is a preset value;
selecting an unselected matching point pair from matching point pairs in the two frames of images;
retaining a selected matching point pair in a case where a state of a grid where one point in the selected matching point pair is located is null, and setting states of grids where two points in the selected matching point pair are located to be non-null; and deleting a selected matching point pair in a case where the states of the grids where the two points in the selected matching point pair are located are all non-null; and
returning to perform an operation of selecting an unselected matching point pair from matching point pairs in the two frames of images, in a case where the unselected matching point pair exists among the matching point pairs in the two frames of images.

4. The method according to claim 1, wherein the calculating a global rotation initial value of a current frame of image and an intrinsic matrix of an image acquiring apparatus according to a matching relationship between the current frame of image and each of K frames of images before and after the current frame of image comprises:
calculating a fundamental matrix between the current frame of image and each of K frames of images before and after the current frame of image according to the matching relationship between the current frame of image and each of K frames of images before and after the current frame of image; and
calculating the global rotation initial value of the current frame of image and the intrinsic matrix of the image acquiring apparatus according to multiple obtained fundamental matrices.

5. The method according to claim 4, wherein the calculating the global rotation initial value of the current frame of image and the intrinsic matrix of the image acquiring apparatus according to the multiple obtained fundamental matrices comprises:
calculating a relative rotation relationship and a relative translation relationship between the current frame of image and each of K frames of images before and after the current frame of image, and the intrinsic matrix of the image acquiring apparatus according to the multiple fundamental matrices; and
calculating the global rotation initial value of the current frame of image according to the relative rotation relationship between the current frame of image and each of K frames of images before and after the current frame of image.

6. The method according to claim 1, further comprising:
calculating a global displacement of the current frame of image according to a relative translation relationship between the current frame of image and each of K frames of images before and after the current frame of image in a case where an average re-projection error of two-dimension spatial points in the current frame of image is greater than or equal to a preset error threshold;
calculating a track of a three-dimension spatial point corresponding to a matching point pair according to positions of corresponding two-dimension spatial points of the matching point pair in multiple frames of images;
triangulating the track of the three-dimension spatial point according to the global rotation optimization value of the current frame of image and the global displacement of the current frame of image to calculate a position of the three-dimension spatial point in a world coordinate system; and
performing global bundle adjustment optimization on the global rotation optimization value and the global displacement of the current frame of image and positions of three-dimension spatial points corresponding to multiple matching point pairs in the current frame of image in the world coordinate system to calculate a global rotation estimated value and an global displacement estimated value of the current frame of image, and coordinate estimated values of the three-dimension spatial points corresponding to the multiple matching point pairs in the current frame of image in the world coordinate system.

7. The method according to claim 6, wherein the calculating a track of a three-dimension spatial point corresponding to a matching point pair according to positions of corresponding two-dimension spatial points of the matching point pair in multiple frames of images comprises:
calculating a connected domain by taking a matching relationship of two-dimension spatial points between two adjacent frames of images as an edge and the two-dimension spatial points as nodes; and
taking the connected domain as a track of a three-dimension spatial point corresponding to the two-dimension spatial points.

8. The method according to claim 7, further comprising:
dividing each frame of image into N×N grids, wherein an initial state of each grid is null, and N is a preset value;
selecting a track of an unselected three-dimension spatial point from tracks of multiple three-dimension spatial points;
retaining a track of a selected three-dimension spatial point in a case where a state of a grid where at least one two-dimension spatial point in the track of the selected three-dimension spatial point is located is null, and setting states of grids where all the two-dimension spatial points corresponding to the track of the selected three-dimension spatial point are located to be non-null; deleting the track of the selected three-dimension spatial point in a case where the states of the grids where all the two-dimension spatial points corresponding to the track of the selected three-dimension spatial point are located are non-null; and
returning to perform an operation of selecting a track of an unselected three-dimension spatial point from tracks of multiple three-dimension spatial points, in a case where the track of the unselected three-dimension spatial point exists among the tracks of the multiple three-dimension spatial points.

9. The method according to claim 1, further comprising:
calculating a global rotation estimated value, a global displacement estimated value of the current frame of image, and coordinate estimated values of three-dimension spatial points corresponding to multiple matching point pairs in the current frame of image in a world coordinate system by a global structure from motion algorithm in a case where an average re-projection error of two-dimension spatial points in the current frame of image is greater than or equal to a preset error threshold.

10. An apparatus for estimating video rotation, comprising a preliminary computation module and an optimization module, wherein
the preliminary computation module is configured to calculate a global rotation initial value of a current frame of image and an intrinsic matrix of an image acquiring apparatus according to a matching relationship between the current frame of image and each of K frames of images before and after the current frame of image for each frame of image in a video to be processed, wherein K is a natural number, and the K frames of images before and after the current frame of image comprise K frames of images before the current frame of image and K frames of images after the current frame of image;
the optimization module is configured to calculate a homography matrix between the current frame of image and each of M frames of images before and after the current frame of image according to a matching relationship between the current frame of image and each of M frames of images before and after the current frame of image, wherein M is a natural number less than or equal to K, and the M frames of images before and after the current frame of image comprise M frames of images before the current frame of image and M frames of images after the current frame of image; set a loss function according to the global rotation initial value of the current frame of image and the intrinsic matrix of the image acquiring apparatus, and minimizing the loss function by using an optimization method to obtain a final loss function; and calculate a global rotation optimization value of the current frame of image according to the final loss function and multiple homography matrices.

11. The apparatus according to claim 10, wherein
the optimization module is further configured to calculate a global displacement of the current frame of image according to a relative translation relationship between the current frame of image and each of K frames of images before and after the current frame of image in a case where an average re-projection error of two-dimension spatial points in the current frame of image is greater than or equal to a preset error threshold; calculate a track of a three-dimension spatial point corresponding to a matching point pair according to positions of corresponding two-dimension spatial points of the matching point pair in multiple frames of images; triangulating the track of the three-dimension spatial point according to the global rotation optimization value of the current frame of image and the global displacement of the current frame of image to calculate a position of the three-dimension spatial point in a world coordinate system; and performing global bundle adjustment optimization on the global rotation optimization value and the global displacement of the current frame of image and positions of three-dimension spatial points corresponding to multiple matching point pairs in the current frame of image in the world coordinate system to calculate a global rotation estimated value and an global displacement estimated value of the current frame of image, and coordinate estimated values of the three-dimension spatial points corresponding to the multiple matching point pairs in the current frame of image in the world coordinate system.

12. An electronic device, comprising a memory, a processor, a bus, and a computer program that is stored on the memory and executable on the processor, wherein the processor, when executing the computer program, implements the method for estimating video rotation according to claim 1.

13. A non-transient computer-readable storage medium storing a computer program that, when executed by a processor, implements a method for estimating video rotation, wherein the method comprises:
calculating a global rotation initial value of a current frame of image and an intrinsic matrix of an image acquiring apparatus according to a matching relationship between the current frame of image and each of K frames of images before and after the current frame of image for each frame of image in a video to be processed, wherein K is a natural number, and the K frames of images before and after the current frame of image comprise K frames of images before the current frame of image and K frames of images after the current frame of image;
calculating a homography matrix between the current frame of image and each of M frames of images before and after the current frame of image according to a matching relationship between the current frame of image and each of M frames of images before and after the current frame of image, wherein M is a natural number less than or equal to K, and the M frames of images before and after the current frame of image comprise M frames of images before the current frame of image and M frames of images after the current frame of image;
setting a loss function according to the global rotation initial value of the current frame of image and the intrinsic matrix of the image acquiring apparatus, and minimizing the loss function by using an optimization method to obtain a final loss function; and
calculating a global rotation optimization value of the current frame of image according to the final loss function and multiple homography matrices.

14. The apparatus according to claim 10, wherein the optimization module is configured for:
downsampling the matching relationship between the current frame of image and each of M frames of images before and after the current frame of image; and
calculating the homography matrix between the current frame of image and each of M frames of images before and after the current frame of image according to multiple downsampled matching relationships.

15. The apparatus according to claim 14, wherein the optimization module is configured for:
dividing each of the two frames of images into corresponding N×N grids, wherein an initial state of each grid is null, and N is a preset value;
selecting an unselected matching point pair from matching point pairs in the two frames of images;
retaining a selected matching point pair in a case where a state of a grid where one point in the selected matching point pair is located is null, and setting states of grids where two points in the selected matching point pair are located to be non-null; and deleting a selected matching point pair in a case where the states of the grids where the two points in the selected matching point pair are located are all non-null; and
returning to perform an operation of selecting an unselected matching point pair from matching point pairs in the two frames of images, in a case where the unselected matching point pair exists among the matching point pairs in the two frames of images.

16. The apparatus according to claim 10, wherein the preliminary computation module is configured for:
calculating a fundamental matrix between the current frame of image and each of K frames of images before and after the current frame of image according to the matching relationship between the current frame of image and each of K frames of images before and after the current frame of image; and
calculating the global rotation initial value of the current frame of image and the intrinsic matrix of the image acquiring apparatus according to multiple obtained fundamental matrices.

17. The apparatus according to claim 16, wherein the preliminary computation module is configured for:
calculating a relative rotation relationship and a relative translation relationship between the current frame of image and each of K frames of images before and after the current frame of image, and the intrinsic matrix of the image acquiring apparatus according to the multiple fundamental matrices; and
calculating the global rotation initial value of the current frame of image according to the relative rotation relationship between the current frame of image and each of K frames of images before and after the current frame of image.

18. The apparatus according to claim 11, wherein the optimization module is configured for:
calculating a connected domain by taking a matching relationship of two-dimension spatial points between two adjacent frames of images as an edge and the two-dimension spatial points as nodes; and
taking the connected domain as a track of a three-dimension spatial point corresponding to the two-dimension spatial points.

19. The apparatus according to claim 18, wherein the optimization module is further configured for:
dividing each frame of image into N×N grids, wherein an initial state of each grid is null, and N is a preset value;
selecting a track of an unselected three-dimension spatial point from tracks of multiple three-dimension spatial points;
retaining a track of a selected three-dimension spatial point in a case where a state of a grid where at least one two-dimension spatial point in the track of the selected three-dimension spatial point is located is null, and setting states of grids where all the two-dimension spatial points corresponding to the track of the selected three-dimension spatial point are located to be non-null; deleting the track of the selected three-dimension spatial point in a case where the states of the grids where all the two-dimension spatial points corresponding to the track of the selected three-dimension spatial point are located are non-null; and
returning to perform an operation of selecting a track of an unselected three-dimension spatial point from tracks of multiple three-dimension spatial points, in a case where the track of the unselected three-dimension spatial point exists among the tracks of the multiple three-dimension spatial points.

20. The apparatus according to claim 10, wherein the optimization module is further configured for:
calculating a global rotation estimated value, a global displacement estimated value of the current frame of image, and coordinate estimated values of three-dimension spatial points corresponding to multiple matching point pairs in the current frame of image in a world coordinate system by a global structure from motion algorithm in a case where an average re-projection error of two-dimension spatial points in the current frame of image is greater than or equal to a preset error threshold.
